(19) United States
(12) Patent Application Publication
(10) Pub. No.: US 2004/0226169 A1
(43) Pub. Date: Nov. 18, 2004

(54) Pull tab for extracting electrical connector

(76) Inventors: Chia-Ming Kuo, Tu-chen (TW); Lung-Sheng Tai, Tu-chen (TW); Zhen-Da Hung, Tu-chen (TW); Hsien-Chu Lin, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/623,066

(22) Filed: Jul. 17, 2003

(30) Foreign Application Priority Data
May 16, 2003 (TW) 92209064

(51) Int. Cl. B23P 19/00

(52) U.S. Cl. 29/764; 29/762

(57) ABSTRACT

A pull tab (1) is adapted to extract an electrical connector (2) from a mating electrical device. The electrical connector includes a mating portion (20) and a retaining portion (21). The pull tab includes an engaging portion (11) and a handling portion (12). The engaging portion has a bottom section (110) and a top section (111). The bottom section has an engaging hole (114) adapted for engaging with the mating portion of the electrical connector. The handling portion extends from the top section for receiving an extracting force for extracting the electrical connector from the mating electrical device.

### CROSS-REFERENCE TO RELATED APPLICATION

This application is relevant to a co-pending patent application entitled “EXTRACTION TAB FOR EXTRACTING ELECTRICAL CONNECTOR”, invented by Lung-Sheng Tai et al, and assigned to the same assignee of the present application.

### BACKGROUND OF THE INVENTION

1. Field of the Invention

The present invention relates to a pull tab, and more particularly, to a pull tab for extracting an electrical connector from a mating electrical device which mates with the electrical connector.

2. Description of Prior Art

To comply with the current trend of light weight and compactness, many electrical devices tend to employ small connectors for transmitting signals. These connectors need to mate tightly with corresponding devices for transmitting signals reliably, which usually requires a great amount of applied force to extract these connectors from these devices when there is necessary to replace these connectors with other connectors for different applications. Their separation is normally accomplished by manually shaking the connectors (or perhaps with prying tools) when the connectors are pulled away from the devices. However, the shaking action to the connectors inevitably bends the contacts of the small connectors and damages the connectors and/or the devices. It is also difficult to manually pull a connector having a very small size.

In order to solve the above-mentioned problems, U.S. Pat. No. 4,961,256 discloses a conventional extraction tool. To separate an electrical connector from an electrical device, the extraction tool is inserted between the electrical connector and the electrical device. The tool is relatively thick so that it cannot be used for the present miniature electrical connector since there is no space large enough between the connector and the electrical device to accommodate the tool.

Japanese Publication for Laid-Open Patent Application No. 0.11-208461 discloses an extraction tab for extracting an L-shape connector from a mating device. The L-shape connector includes a mating portion and a retaining portion extending perpendicularly from the mating portion for retaining a cable. The extraction tab defines an aperture surrounded by a peripheral portion for engaging with a mating portion of the connector. The peripheral portion exerts an extracting force on the mating portion when the connector is extracted. However, the extracting force exerted on the connector fastens on a rear end of the mating portion adjacent to the retaining portion, so it is difficult to extract the connector from the mating device. Furthermore, the extracting force fastening on the rear end of the mating portion may make the mating portion tend to yield or become damaged after a long term of use, resulting in an unreliable connection of the connector with the mating electrical device.

Hence, an improved extraction tool is desired to overcome the disadvantages of the prior arts.

### BRIEF SUMMARY OF THE INVENTION

The main object of the present invention is to provide a pull tab for extracting an electrical connector from a mating electrical device without damaging the electrical connector.

Another object, of the present invention is to provide a pull tab easy to extract the electrical connector from the mating electrical device.

A pull tab in accordance with the present invention is adapted to extract an electrical connector from a mating electrical device. The electrical connector comprises a mating portion and a retaining portion extending perpendicularly from the mating portion for retaining a cable.

The pull tab pull tab includes an engaging portion and a handling portion. The engaging portion has a bottom section and a top section. The bottom section has an engaging hole adapted for engaging with the mating portion of the electrical connector. The handling portion extends from the top section for receiving an extracting force for extracting the electrical connector from the mating electrical device.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a pull tab according to the present invention and an electrical connector.

FIG. 2 is a partial-assembled view of the tact switch and the electrical connector.

FIG. 3 is an assembled view of the pull tab and the electrical connector.

FIG. 4 is a view similar to FIG. 3, illustrating the pull tab in a free state ready to be used to extract the connector.

### DETAILED DESCRIPTION OF THE INVENTION

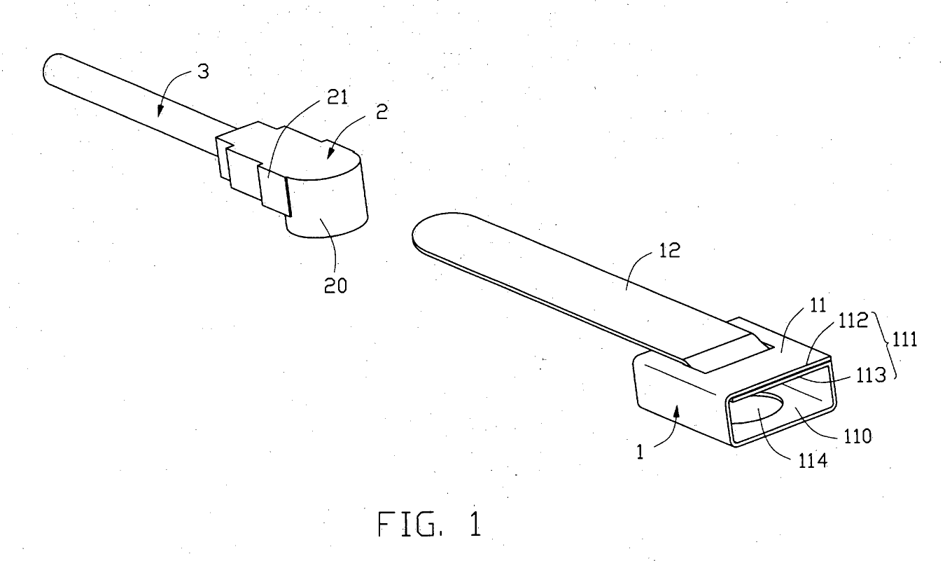

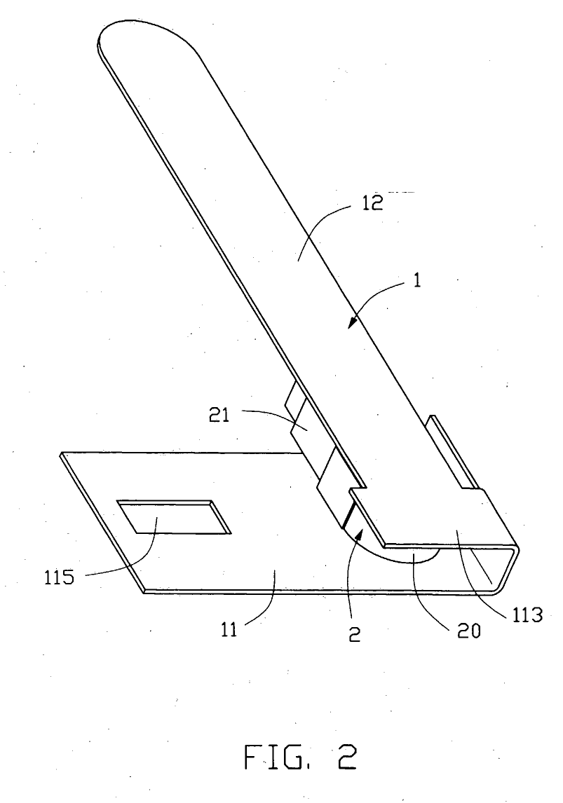

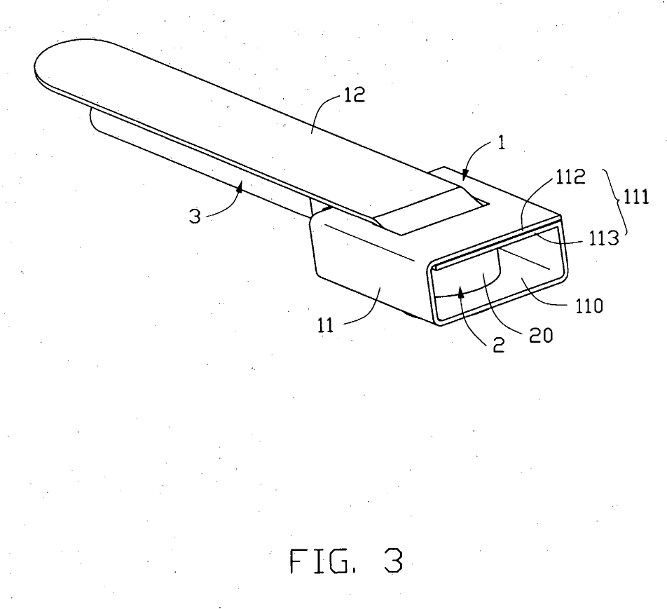

Referring to FIGS. 1, 2 and 3, a pull tab 1 in accordance with the present invention is provided to extract an electrical connector 2 from a mating electrical device (not shown) which mates with the electrical connector 2. In this preferred embodiment, the electrical connector 2 is an RF (Radio Frequency) cable connector having an L-shape configuration.

The RF cable connector 2 comprises an upright mating portion 20 and a retaining portion 21 for retaining a cable 3. The retaining portion 21 extends horizontally and rearwardly from an upside of the mating portion 20.

The pull tab 1 is made of a resilient dielectric material. The pull tab 1 comprises a rectangular engaging portion 11 and a horizontal handling portion 12 extending rearwardly from the engaging portion 11. The engaging portion 11 has a bottom section 110, a top section 111 and two side sections (not labeled) connecting the bottom section 110 with the top section 111. The bottom section 110 defines a substantially circular hole 114 in a central portion thereof. The profile of the hole 114 is properly configured corresponding to an outer profile of a lower portion (not labeled) of the mating portion 20. Thus, the engaging portion 11 could firmly engage with the mating portion 20. The top section 111 has a first plate 112 and a second plate 113. The first plate 112 defines a substantially rectangular opening 115 in a central portion thereof. The handling portion 12 extends horizontally and rearwardly from the second plate 113.

In assembly, the circular hole 114 of the pull tab 1 encircles the lower portion of the mating portion 20 of the electrical connector 2. The second plate 113 and the handling portion 12 extending from the second plate 113 cover an upper surface of the electrical connector 2. The first plate 112 is bent upwardly and overlapped on the second plate 113, at the same time the handling portion 12 passes through the opening 115 for facilitating manual extraction operation to extract the electrical connector 2 from the mating electrical device. The overlapped region of the first plate 112 and the second plate 113 lies over the mating portion 20 of the electrical connector 2. The first plate 112 and the second plate 113 are adhered together for preventing them from separating in use.

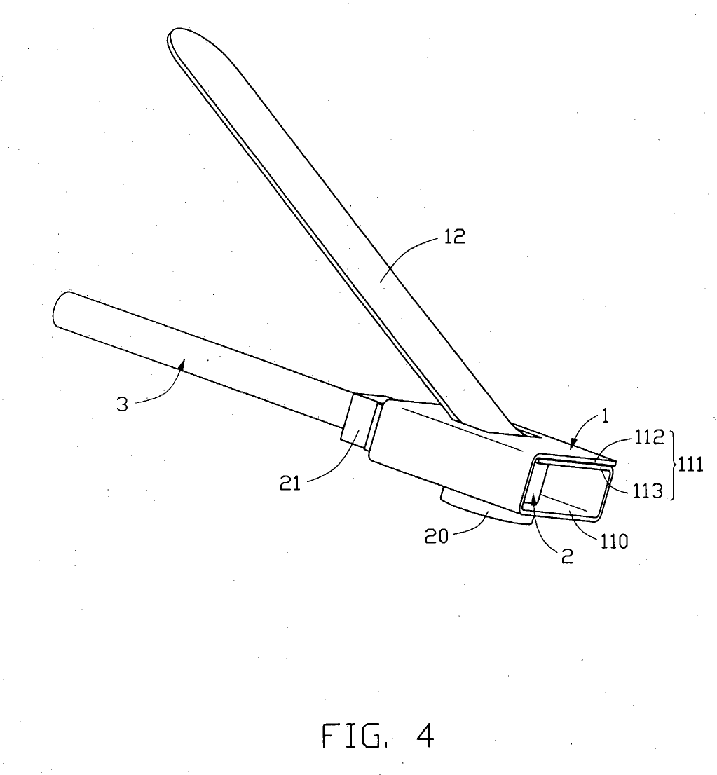

In use, referring to FIG. 4, holding and upwardly pulling the handling portion 12 of the pull tab 1, an extracting force is exerted on the handling portion 12. The extracting force is transferred to the electrical connector 2 by the engagement of the mating portion 20 and the hole 114, then upwardly pulling the electrical connector 2 out of the mating electrical device.

An advantage of the present invention over the prior art results from the fact that the extracting force on the mating portion 20 is substantially and symmetrically dispersed on the periphery of the mating portion 20 of the electrical connector 2. As a result, it is easy to extract the electrical connector from the mating electrical device, furthermore the electrical connector may not be damaged by unbalanced force.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pull tab for extracting a connector from a mating electrical device, the connector comprising a mating portion and a retaining portion extending from the mating portion, the pull tab comprising:
an engaging portion having a top section and a bottom section, the bottom section having an engaging hole adapted for receiving the mating portion of the connector; and
a handling portion extending from the top section and being adapted for receiving an extracting force for extracting the connector from the mating electrical device.

2. The pull tab as described in claim 1, wherein the top section comprises a first plate and a second plate overlapped with the first plate.

3. The pull tab as described in claim 2, wherein the first plate has, an opening, the handling portion extends from the second plate and passes through the opening.

4. The pull tab as described in claim 3, wherein the overlapped region of the first plate and the second plate lies over the mating portion of the connector, and the first plate and second plate are adhered together for preventing them from separating.

5. The pull tab as described in claim 4, wherein the engaging portion has a rectangular shape.

6. The pull tab as described in claim, 1, wherein the pull tab is made of a resilient dielectric material.

7. An electrical connector assembly comprising:
an electrical connector comprising a mating portion and a retaining portion extending from the mating portion; and
a pull tab for extracting the electrical connector from a mating electrical device which mates with the electrical connector, comprising:
an engaging portion having a top section and a bottom section, the bottom section having an engaging hole adapted for receiving the mating portion of the connector; and
a handling portion extending from the top section and being adapted for receiving an extracting force for extracting the electrical connector from the mating electrical device.

8. The electrical connector assembly as described in claim 7, wherein the top section comprises a first plate and a second plate overlapped with the first plate.

9. The electrical connector assembly as described in claim 8, wherein the first plate has an opening, the handling portion extends from the second plate and passes through the opening.

10. The electrical connector assembly as described in claim 9, wherein the overlapped region of the first plate and the second plate lies over the mating portion of the connector, and the first plate and second plate are adhered together for preventing them from separating.

11. The electrical connector assembly as described in claim 10, wherein the engaging portion has a rectangular shape.

12. The electrical connector assembly as described in claim 7, wherein the pull tab is made of a resilient dielectric material.

13. An electrical connector assembly comprising:
an electrical connector comprising a vertically extending lower mating portion and a horizontally extending upper retaining portion; and
a pull tab including an engaging portion defining a cavity which is configured to compliantly receive the retaining portion therein with the mating portion downwardly extending therefrom; and
a handle portion extending from an upper portion of the engaging portion with a root section being located right above the mating portion.

14. The electrical connector assemble as described in claim 13, wherein said cavity horizontally communicates with an exterior in a direction along which a cable extends from the retaining portion.

15. The electrical connector assembly as described in claim 14, wherein the engaging portion includes a bottom wall through which the mating portion extends downwardly, and an opposite top wall from which the handle portion extends.

16. The electrical connector assembly as described in claim 15, wherein said top wall includes stacked upper and lower layers, and the handle portion extends from the lower layer and through an opening of the upper layer generally along said direction.
